(19) United States
(12) Patent Application Publication
(10) Pub. No.: US 2009/0015617 A1
(43) Pub. Date: Jan. 15, 2009

(54) INKJET RECORDING DEVICE

(75) Inventors: Jouji ODAKA, Saitama-shi (JP); Shinichi Saijo, Noda-shi (JP); Hirohisa Niida, Tokyo (JP)

Correspondence Address: PATENTTM.US, P. O. BOX 82788, PORTLAND, OR, 97282-0788, US

(73) Assignee: CANON FINETECH INC., Misato-shi (JP)

(21) Appl. No.: 12/168,766

(22) Filed: Jul. 7, 2008

(30) Foreign Application Priority Data
Jul. 13, 2007 (JP) 2007-184169

(51) Int. Cl. B41J 29/38

(52) U.S. Cl. 347/16

(57) ABSTRACT

An inkjet recording device having a line type recording head detects the conveyance speed of a recording medium (S401) and changes the conveyance-direction recording resolution of the recording head and the driving control method of the recording head according to the detected conveyance speed (S403-S413). The change of this driving control method is that the pulse width of a driving pulse applied to the recording elements of the recording head is changed based on coefficients determined according to the detected conveyance speed or that the divided driving interval used for divided driving control is changed. Changing the driving control method in this way allows the user to print at a desired conveyance speed with no concern for various print settings.

### DETAILED DESCRIPTION

1. Field of the Invention

The present invention relates to an inkjet recording device on which a line type recording head is mounted and which performs recording in synchronization with the conveyance speed of a recording medium, and more particularly to the recoding control of the inkjet recording device.

2. Related Art

Conventionally, there is a recording device that is mounted on a conveyance device independently of this conveyance device and that receives a signal from a linear encoder, installed on the conveyance device, for forming an image in synchronization with the conveyance speed (see Patent Document 1). This recording device has an advantage in that a user is allowed to add a recording device on an already-built conveyance line and in that the user can set the conveyance speed arbitrarily.

[Patent Document 1] Japanese Patent Laid-Open Publication No. Hei 11-170623

However, though the recording device that forms an image in synchronization with a signal from the conveyance device as in the conventional example allows the user to determine the conveyance speed arbitrarily, the recording device side has no way to know the print speed in advance and so, the control software must be incorporated assuming the worst condition produced, for example, when the highest speed within the prescribed speed range is used.

Another recording device is also available that allows the user to set the conveyance-direction resolution so that an image can be printed at a high speed only when the resolution is low. However, this method is cumbersome because the user must change and confirm the setting each time the resolution setting is changed. Another problem with that recording device is a decrease in efficiency because, when high-speed printing is mistakenly started with a high resolution specified, the user is notified about the error, and becomes aware of the setting error, after the print operation is started. Because a recording device with that configuration is used especially for industrial applications in many cases, there is a need to eliminate cumbersome settings and print errors to ensure productivity.

### SUMMARY OF THE INVENTION

In view of the foregoing, it is an object of the present invention to provide an inkjet recording device that eliminates the need for the user to be concerned about the print settings and allows the user to print at a desired conveyance speed.

An inkjet recording device of the present invention comprises a line type recording head; a speed detection unit that detects a conveyance speed of a recording medium conveyed to the line type recording head; and a recording control unit that controls recording of an image, recorded by the recording head, according to the detected conveyance speed. This recording control unit changes a conveyance-direction recording resolution of the recording head and a driving control method of the recording head according to the detected conveyance speed.

The conveyance control of the recording medium is performed by a conveyance device that is independent of the inkjet recording device, and the recording control unit controls the driving of the recording head differently according to the conveyance speed of the recording medium. The “independence” means that the recording device and the conveyance device are separate in structure when the recording device is shipped.

The change of the recording resolution is performed, for example, by thinning out a raster of image data according to the detected conveyance speed.

Preferably, the recording control unit divides nozzles of the recording head into a plurality of groups, each of which is driven at a time, and performs divided driving control in which ink is ejected sequentially on a group basis in order to reduce a peak value of a driving current applied to the recording head.

The change of the driving control method according to the conveyance speed is, for example, a change performed by changing a pulse width of a driving pulse, applied to recording elements of the recording head, based on coefficients determined according to the detected conveyance speed or a change performed by changing a divided driving interval used for the divided driving control.

Preferably, the user can selectively set a mode in which the recording resolution of an image is changed according to the detected conveyance speed or a mode in which an image is recorded at a fixed recording resolution.

Preferably, the user can selectively set a mode in which driving is controlled differently according to the detected conveyance speed or a mode in which an image is recorded in a fixed driving control method.

The conveyance speed is detected based on an output signal from an encoder installed on a conveyance device.

The present invention allows the user to start printing at a desired conveyance speed with no concern for the various print settings and, thus, to perform appropriate print control automatically. Especially, an error caused by a setting error in an industrial printing unit causes a print job to stop, sometimes resulting in a business loss. The present invention is applicable to those uses.

### BRIEF DESCRIPTION OF THE DRAWINGS

FIG. 1 is a diagram showing the main part of a recording system in an embodiment of the present invention as well as a host computer that is an external device.

FIG. 2 is a block diagram showing an example of the configuration of control hardware of a recording device in the embodiment of the present invention.

FIG. 3 is a diagram showing the recording control of the recording device in the embodiment of the present invention.

FIG. 4 is a flowchart showing the control flow of the recording system in the embodiment of the present invention.

FIG. 5 is a diagram showing the conveyance-direction recording resolution setting in the recording system in the embodiment of the present invention.

FIG. 6A is a diagram showing the divided driving interval in the embodiment of the present invention and FIG. 6B is a diagram showing the recording head driving pulse.

FIG. 7 is a diagram showing a driving pulse control table, which is an example of driving pulse control, indicating the relation between the temperature of the area adjacent to a nozzle and a change in the pulse adjustment amount dependent on the conveyance speed.

### DETAILED DESCRIPTION OF THE PREFERRED EMBODIMENT

An embodiment of the present invention will be described in detail below with reference to the drawings.

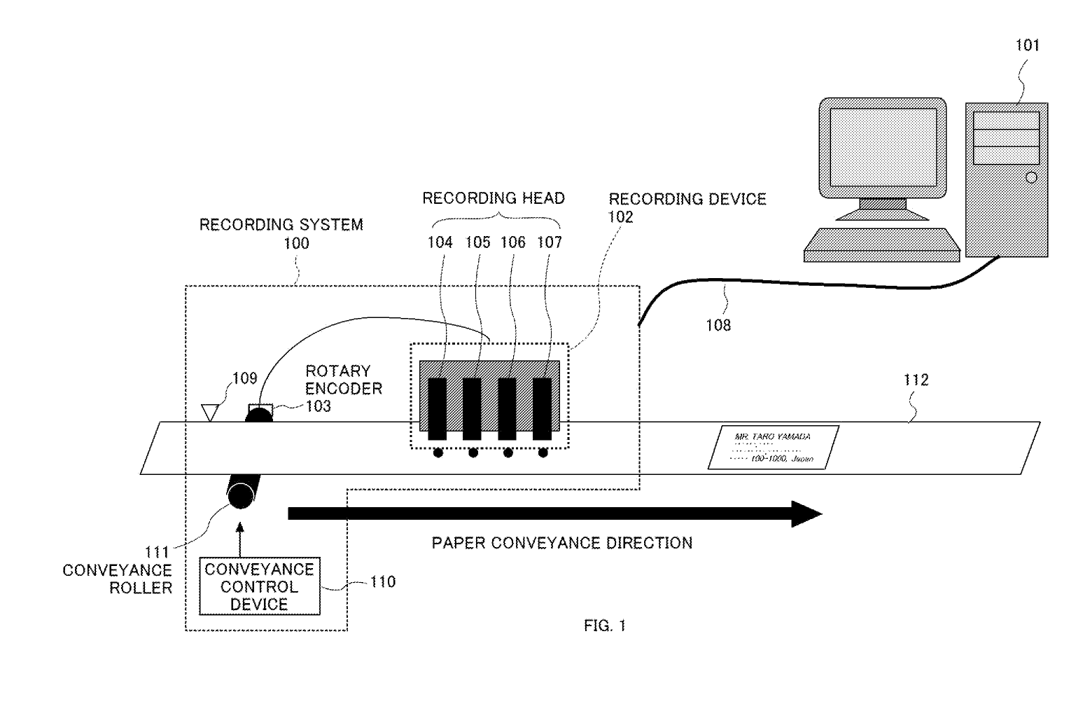

FIG. 1 is a diagram showing the main part of a recording system 100 in this embodiment and a host computer 101 that is an external device. A recording device 102, on which recording heads 104-107 are mounted, is connected to the host computer 101 via a USB cable 108, which is a printer cable, to configure the recording system 100. As the multiple recording heads 104-107, the recording device 102 uses four long line-type recording heads (also called line head) in the inkjet recording method where multiple recording elements are arranged across the whole width of a recording medium. This recording system has a conveyance control device 110 that controls the conveyance device of a recording medium 112 independently of the recording device 102 for conveying the recording medium such as a paper sheet at a user-specified speed. The conveyance device includes a conveyance mechanism (not shown) including a conveyance roller 111 and a rotary encoder (or linear encoder) 103, etc. In this embodiment, each recording head is assumed to be capable of printing at the conveyance speed of 60 m/min with the conveyance-direction resolution of 600 dpi.

The recording device 102 receives various types of data, processed by the host computer 101, and records the data as an image. The recording device 102 in this embodiment supplies ink of the same color (for example, black) from a common ink tank (not shown) to the four line-type recording heads 104-107. In this example, a recording medium that is a continuous form is supplied under the recording heads and, when a recording medium detection sensor 109 detects the recording medium, an image is printed sequentially on the recording medium by the recording heads 104-107 in synchronization with the output signal of the rotary encoder 103 (hereinafter simply called an encoder) connected to the conveyance device. Note that the recording medium detection sensor 109 reads marks printed in advance on the recording medium at a predetermined interval. It is also possible that, instead of mounting the recording medium detection sensor 109, an external signal is used as a trigger to start printing.

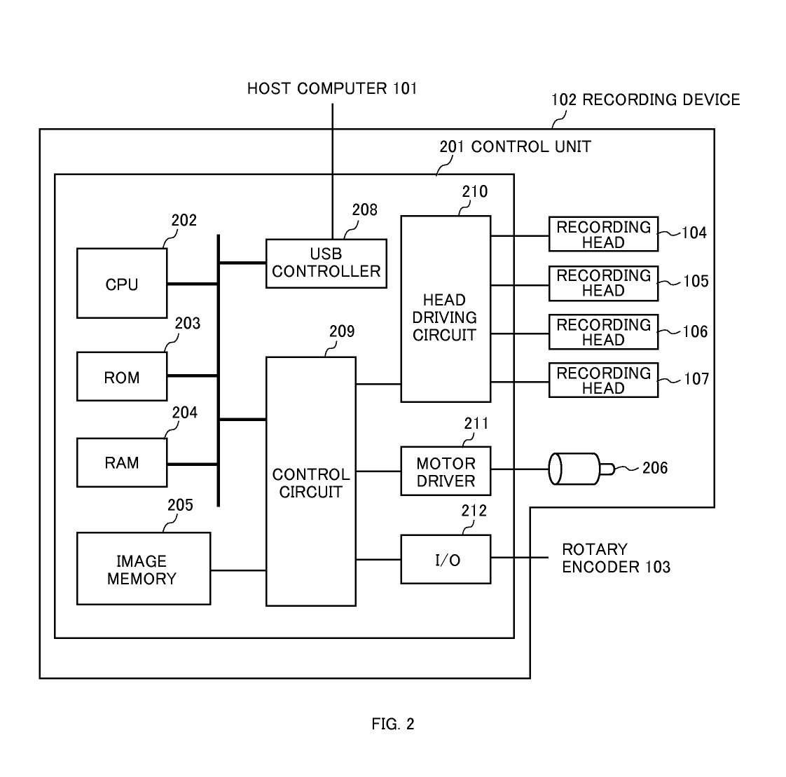

FIG. 2 is a block diagram showing an example of the configuration of the control hardware of the recording device in this embodiment. A control unit 201 has a central processing unit (CPU) 202 that executes the control program, stored in a non-volatile memory (ROM) 203, for controlling the peripheral devices. The control unit 201 also has a memory (RAM) 204, used as a work area for processing various types of data or as a receiving buffer, and an image memory 205 used as an image expansion area. In addition, the control unit 201 has a control circuit 209 that controls a head driving circuit 210, a motor driver 211, and an interface unit (I/O) 212 under control of the CPU 202. The head driving circuit 210 is a circuit for driving the recording heads 104-107. The motor driver 211 is a part that drives motors 206 for controlling the cleaning operation for keeping the recording heads in the optimum recording status and for controlling the recording operation. The interface unit (I/O) 212 is a part that works as an interface with the encoder 103 of the paper conveyance device for supplying and conveying a paper under the recording heads.

Basically, this recording device has a USB controller 208 that receives image data and the cleaning command from the host computer 101 via the USB cable 108 and performs the operation according to the received commands. Note that the interface is not limited to the USB.

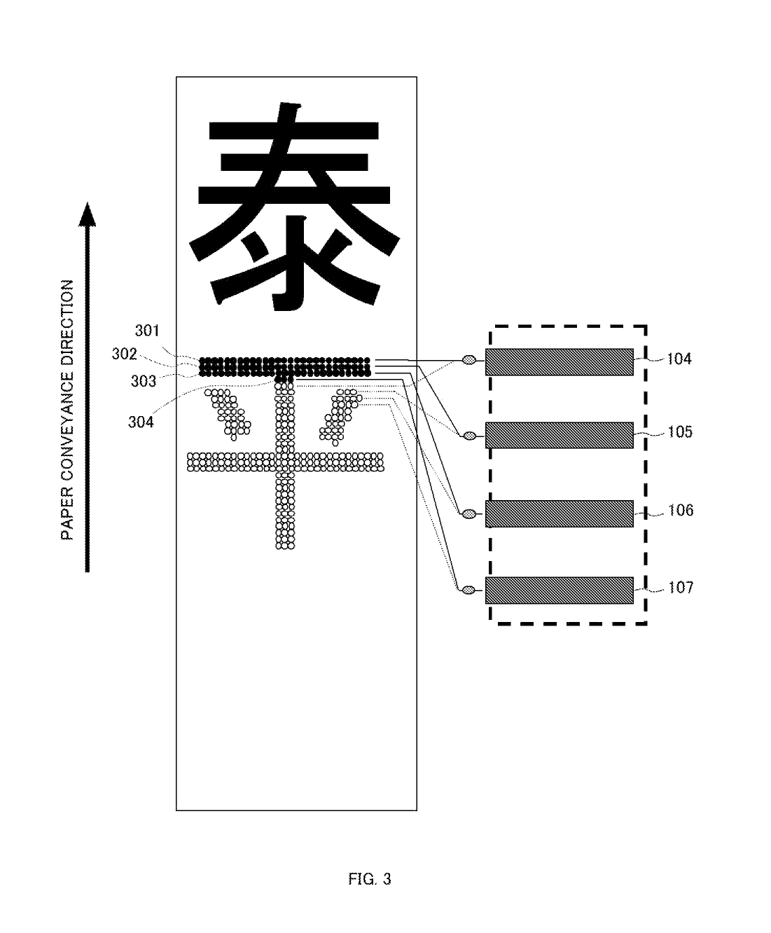

FIG. 3 is a diagram showing the recording control of the recording device in this embodiment.

In synchronization with the output pulse generated by the encoder 103 when a recording medium is conveyed, one raster of data is transferred from the image memory 205 to the recording head 104 to produce a raster drawing 301. Similarly, in synchronization with the next output pulse from the encoder 103, the next one raster of data is transferred from the image memory 205 to the recording head 105 to produce a raster drawing 302. In addition, in synchronization with the next output pulse from the encoder 103, the next one raster of data is transferred from the image memory 205 to the recording head 106 to produce a raster drawing 303. Similarly, the recording head 107 produces a raster drawing 304. Using the recording heads 104-107, one for each raster in this way, produces an output image at a high speed.

To reduce the peak value of the driving current applied to the recording heads, the control unit 201 divides all nozzles of each of the recording heads into multiple groups, each of which is driven at the same time, to perform the divided driving control in which ink is sequentially ejected, one group at a time.

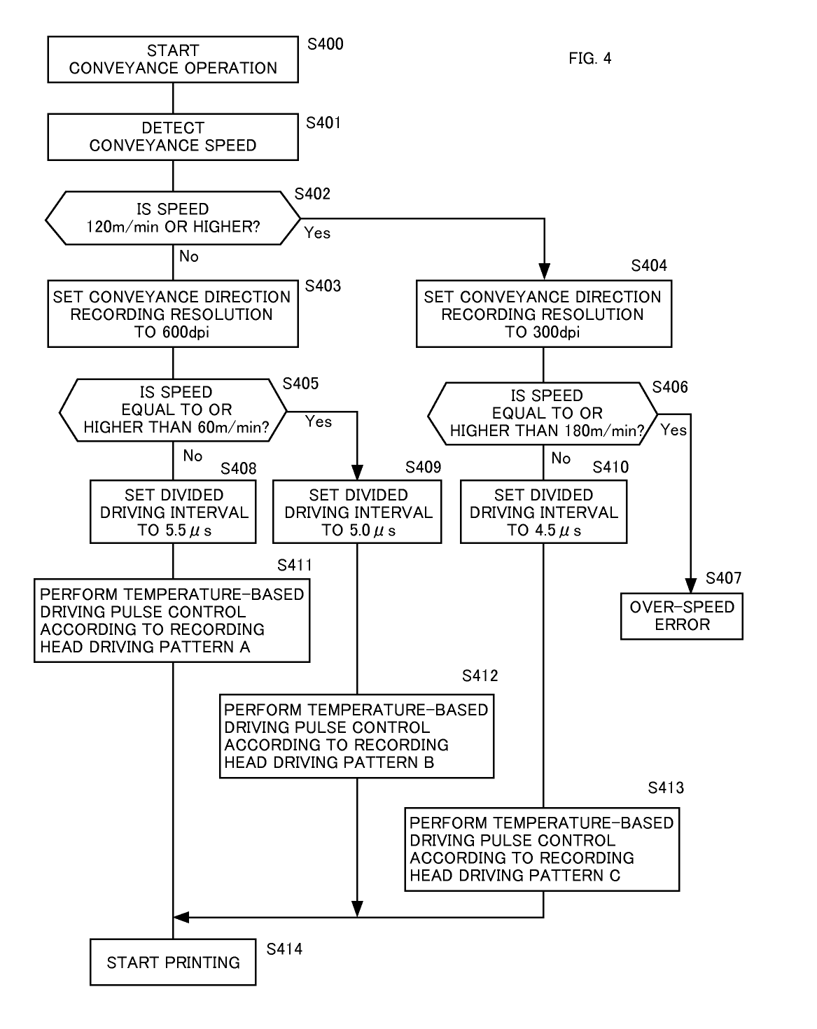

Next, the following describes the control flow of the recording system in this embodiment. FIG. 4 is a flowchart showing the control flow. The program containing the execution procedure of the processing of the flowchart is stored in the ROM (memory) 203 which is interpreted and executed by the CPU 202 for implementing the processing.

First, the host computer 101 sends image data and starts conveying a recording medium according to the instruction from the user (S400). The recording device 102 detects the signal from the encoder 103 of the conveyance device (S401) and checks if the conveyance speed is equal to 120 m/min or higher (S402). If the speed is 120 m/min or higher, the conveyance-direction recording resolution is set to 300 dpi (S404); if the speed is lower than 120 m/min, the conveyance-direction recording resolution is set to 600 dpi (S403). The image data is optimized by variably setting the conveyance-direction resolution in this way according to the conveyance speed. The resolution can be changed by thinning out image data of a raster. A raster corresponds to one line orthogonal to the conveyance direction.

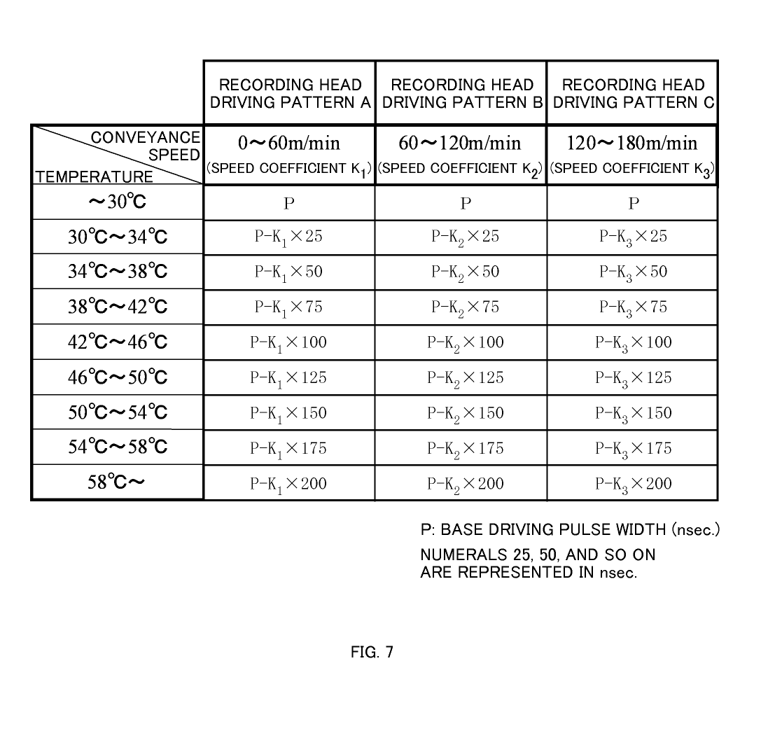

The divided driving interval is set to 5.5 μs (S408) if the conveyance speed is lower than 60 m/min (S405), is set to 5 μs (S409) if the conveyance speed is equal to or higher than 60 m/min and lower than 120 m/min, and is set to 4.5 μs (S410) if the conveyance speed is equal to or higher than 120 m/min and lower than 180 m/min. At the same time, the recording head driving pattern is changed for each speed range, and the temperature-based driving pulse control is performed according to the recording head driving pattern (S411-S413). The change of the recording head driving pattern includes the change of the pulse width of the driving pulse by the “speed coefficient”, which will be described below in detail in FIG. 7, and the change of the divided driving interval. The divided driving interval will be described below in detail. If the conveyance speed is equal to or higher than 180 m/min, an over-speed error is generated (S407). The printing is started when the settings are automatically set by the control software (S414). In this way, the user is required only to send image data from the host computer 101 and set a desired conveyance speed for the recording device 102 to automatically change the print control appropriately.

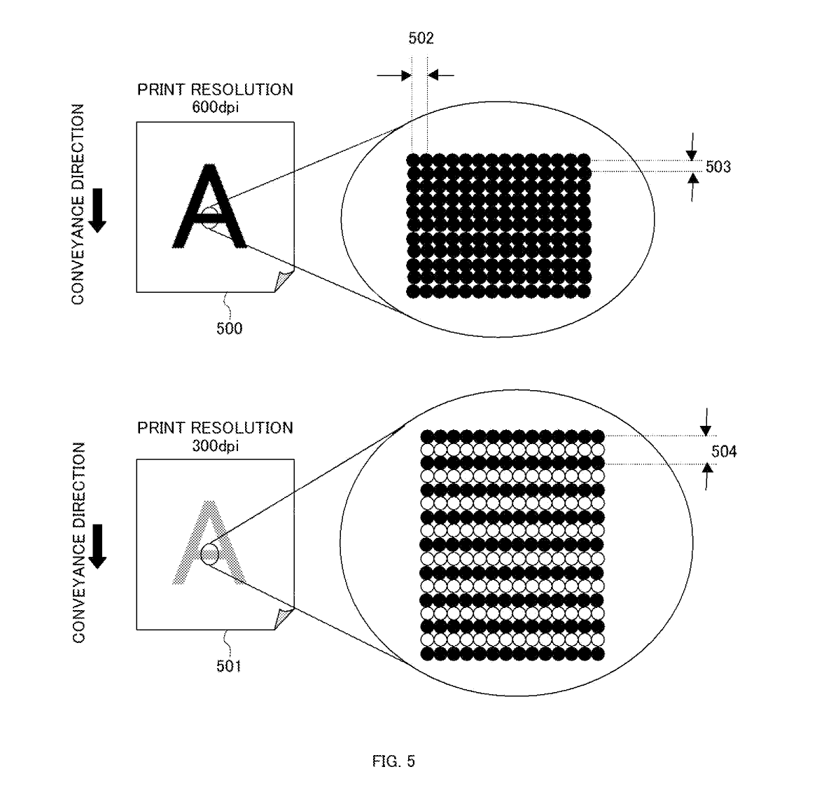

FIG. 5 is a diagram showing the setting of the conveyance-direction recording resolution. When the nozzle resolution is 600 dpi (502) and the conveyance-direction recording resolution is 600 dpi (500), the recording head in this embodiment can print an image with the ejection performance of 60 m/min. In this case, thinning out the raster of image data and setting the conveyance-direction recording resolution to 300 dpi (501) can reduce the recording head ejection frequency by half at the same conveyance speed (503, 504), making the printing speed even higher. Although it is not always true because many factors are involved in an actual situation, it can be simply said that the printing at the conveyance-direction recording resolution of 300 dpi is twice higher than the printing at the conveyance-direction recording resolution of 600 dpi.

In this way, the print system checks if the conveyance speed detected by the encoder 103 is equal to or higher than 60 m/min and, based on the result, automatically switches the conveyance-direction recording resolution. This method allows for a wide range of printing speeds some of which exceed the ejection performance of the heads.

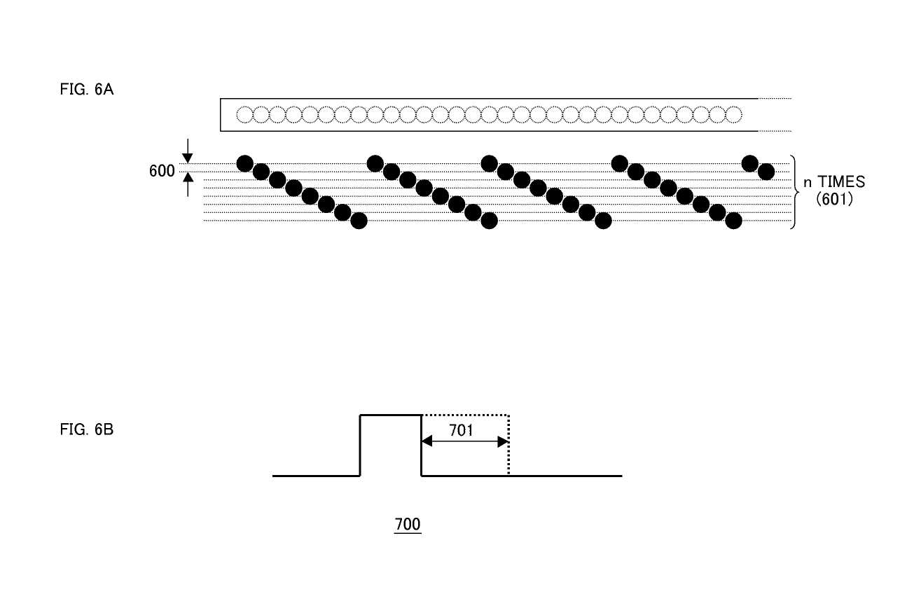

For the sake of the description of a divided driving interval, FIG. 6A is an enlarged diagram showing one horizontal (orthogonal to the conveyance direction) straight line formed by one recording head. In this figure, the dot sequence of one line in the conveyance direction is extremely shifted for the sake of description. On a recording device using long full-line heads such as the one in this embodiment, the current flows at a time and the voltage is decreased when ink is ejected from all nozzles with the result that an ink ejection error is sometimes generated. To solve this problem, the nozzles of the same recording head are conventionally divided into n groups and ink is sequentially ejected n times (601), once for each nozzle group, to perform the divided driving control for reducing the peak current. The time interval at which the nozzles of the groups are driven, one group at a time, under the divided driving control is called a divided driving interval 600.

From the hardware viewpoint, a longer divided driving interval 600 is efficient. On the other hand, because the recording medium is continuously conveyed even during the divided driving, a longer divided driving interval 600 at a high-speed printing time results in a large shift in the landing positions on the recording medium and degrades the quality. To solve this problem, the divided driving interval 600 is controlled according to the detected conveyance speed in such a way that the divided driving interval 600 is set longer for low-speed printing and set shorter for high-speed printing. This method ensures good-quality printing according to the conveyance speed.

FIG. 6B is a diagram showing the driving pulse applied to a recording head. In this embodiment, each firing chamber of the recording head has a heater that, when turned on, heats ink and changes its status to eject it from the chamber for printing. On a recording device in this method, even if the pulse width of a driving pulse 700 applied to the heater is the same, the amount of change in the ink status, as well as the amount of ink that is ejected, varies according to the temperature of the area adjacent to the nozzle. To make the ink ejection droplets the same size, one of generally known methods is that a sensor is provided to detect the temperature of the area adjacent to the nozzle to adjust the driving pulse (701) applied to the heater.

Continued printing causes the heater to continuously generate the thermal energy, increasing the temperature of the area adjacent to the nozzle. That is, as the print speed becomes higher, the ejection period becomes shorter and the temperature tends to rise. In this embodiment, not only the temperature is detected by a known sensor (not shown) to increase and decrease the amount of driving pulses but also the conveyance speed is added to the driving pulse control parameters to finely control the ejection.

As an example of driving pulse control, FIG. 7 shows a driving pulse control table indicating the relation between the temperature of the area adjacent to a nozzle and a change in the pulse adjustment amount dependent on the conveyance speed. The pulse width of the driving pulse when the temperature of the area adjacent to the nozzle is lower than 30° C. is used as the base driving pulse width P, and the pulse of the pulse width, generated by subtracting a predetermined value (pulse width) from the base driving pulse width P, is used as the driving pulse. The “predetermined value” is increased in increments of a predetermined time (25 nsec in this example), such as 25 nsec, 50 nsec, 75 nsec, . . . , as the temperature rises. At this time, the coefficient K1-K3 (positive real number) calculated in advance for the range of the conveyance speed (0-60 m/min, 60-120 m/min, 120-180 m/min in the example in the figure) is multiplied by the “predetermined value” to determine the driving pulse appropriate to the temperature and the conveyance speed. For example, because the temperature tends to rise during high-speed printing, the pulse width for high-speed printing is set smaller than that for low-speed printing even when the temperature of the area adjacent to the nozzle is 50° C. both for high-speed temperature and low-speed temperature. That is, the relation is K1<K2<K3.

Implementing this processing by the control software allows the driving pulse to be automatically adjusted. Although the speed coefficients K1-K3 may be determined once before starting printing, it is desirable that the temperature be sampled, and the driving pulse be determined, at a shorter interval, for example, for each print page, because the temperature of the area adjacent to the nozzle constantly varies.

The inkjet recording device in this embodiment detects the conveyance speed when the printing is started and, based on the detected result, changes the conveyance-direction resolution and the driving pulse control method as described above and, in this way, provides the user with a print result appropriate to a user-desired print speed. In addition, the embodiment requires the user only to send image data and start the conveyance of a recording medium with no need for specifying various settings, thus reducing print errors due to setting errors and ensuring increased productivity.

Although the preferred embodiment of the present invention has been described in detail, it is to be understood that the present invention is not limited to the embodiment and that various other changes and modifications are also possible.

For example, though the recording resolution, the divided driving interval, and the driving pulse width are changed according to the conveyance speed in this embodiment, the control items are not limited to the three. For example, it is also possible that the recording resolution and the divided driving interval are controlled or that only the driving pulse is controlled. It is also possible that the user selects whether to change various control items according to the conveyance speed. For example, the user selects one of two modes: the mode in which the recording resolution is automatically changed according to the conveyance speed and the mode in which an image is recorded at a fixed resolution.

In addition, though the conveyance speed is detected once before the printing in this embodiment to determine the control, the conveyance speed may also be detected for each page or in real time if the conveyance speed can be changed during printing in the system.

Although four monochrome recording heads are mounted on the recording device in the embodiment, the same control can be performed also on a full-color printing unit on which the heads of various colors, such as black, cyan, magenta, yellow, etc., are mounted.

In the embodiment, each firing chamber of the recording head has a heater that, when turned on, causes a change in the ink status to eject ink from the chamber. Instead of this, the recording resolution and the divided driving interval can be changed in the same manner also in a system in which each nozzle has a piezoelectric element that changes its volume to eject ink for printing.

What is claimed is:

1. An inkjet recording device comprising:
a line type recording head;
a speed detection unit that detects a conveyance speed of a recording medium conveyed to said line type recording head; and
a recording control unit that controls recording of an image, recorded by said recording head, according to the detected conveyance speed, wherein
said recording control unit changes a conveyance-direction recording resolution of said recording head and a driving control method of said recording head according to the detected conveyance speed.

2. The inkjet recording device according to claim 1 wherein a conveyance control of said recording medium is performed by a conveyance device that is independent of said inkjet recording device.

3. The inkjet recording device according to claim 1 wherein the change of the recording resolution is performed by thinning out a raster of image data according to the detected conveyance speed.

4. The inkjet recording device according to claim 1 wherein said recording control unit divides nozzles of the recording head into a plurality of groups, each of which is driven at a time, and performs divided driving control in which ink is ejected sequentially on a group basis in order to reduce a peak value of a driving current applied to said recording head.

5. The inkjet recording device according to claim 1 wherein the change of the driving control method according to the conveyance speed is a change performed by changing a pulse width of a driving pulse, applied to recording elements of said recording head, based on coefficients determined according to the detected conveyance speed.

6. The inkjet recording device according to claim 4 wherein the change of the driving control method according to the conveyance speed is a change performed by changing a divided driving interval used for the divided driving control.

7. The inkjet recording device according to claim 1 wherein the user can selectively set a mode in which the recording resolution of an image is changed according to the detected conveyance speed or a mode in which an image is recorded at a fixed recording resolution.

8. The inkjet recording device according to claim 1 wherein the user can selectively set a mode in which driving is controlled differently according to the detected conveyance speed or a mode in which an image is recorded in a fixed driving control method.

9. The inkjet recording device according to claim 7 wherein the user can selectively set a mode in which driving is controlled differently according to the detected conveyance speed or a mode in which an image is recorded in a fixed driving control method.

10. The inkjet recording device according to claim 1 wherein the conveyance speed is detected based on an output signal from an encoder installed on a conveyance device.
